(19) United States
(12) Patent Application Publication
(10) Pub. No.: US 2025/0334388 A1
(43) Pub. Date: Oct. 30, 2025

(54) Boundary Marking Device

(71) Applicant: Randy Ling, Mililani, HI (US)

(72) Inventor: Randy Ling, Mililani, HI (US)

(21) Appl. No.: 18/645,909

(22) Filed: Apr. 25, 2024

(51) Int. Cl. G01B 3/1048; G01B 3/1005; G01B 3/1007

(52) U.S. Cl. CPC G01B 3/1048; G01B 3/1007; G01B 2003/1023

(57) ABSTRACT

A boundary marking device for defining boundaries of an athletic field on a ground surface includes a housing having an interior space. A slit extends through the housing into the interior space. A spool is coupled to the housing within the interior space. A tape is coiled around the spool and extends through the slit. The spool is rotatable in a first direction to uncoil the tape from the spool for extension of the tape from the housing and is rotatable in a second direction to coil the tape around the spool for retraction of the tape into the housing. A housing stake extends downwardly from the housing. The housing stake has a housing stake pointed end that is insertable into the ground surface to secure the housing to the ground surface. A peg has a peg pointed end that is designed to secure the tape to the ground surface.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to sporting goods and more particularly pertains to a new sporting good for temporarily defining boundaries of an athletic field on a ground surface.

### (2) Description of Related Art Including Information Disclosed Under 37 CFR 1.97 and 1.98

The prior art relates to sporting goods. More specifically, the prior art relates to sporting goods which are used to mark or define the boundaries of an athletic field or a court. For example, the prior art discloses cones which may be arranged around the boundaries of the athletic field. However, the cones are discreet objects, rather than continuous or connected lines of material. Younger players can have difficulty seeing the cones and recognizing that the boundary continues along the line between two or more of the cones. Even older players can struggle to recognize the exact boundary line between a pair of cones, which can result in arguments and hostility between players when deciding whether a certain play is “in” or “out” of bounds. Accordingly, the prior art has disclosed devices for marking the ground continuously along the boundaries of the athletic field or court. For example, the prior art discloses paints and adhesive tapes that can be laid on the ground to define the boundaries of the athletic field. However, those devices are far less useful for sports or teams that use certain fields or spaces temporarily. Thus, there is a need for a device which can be temporarily set up to define the boundaries of the athletic field with continuous lines of material that are easily visible to young and old players.

### BRIEF SUMMARY OF THE INVENTION

An embodiment of the disclosure meets the needs presented above by generally comprising a housing having an interior space. A slit extends through the housing into the interior space. A spool is rotatably coupled to the housing. The spool is positioned in the interior space. A tape is coiled around the spool. The spool is rotatable in a first direction to uncoil the tape from the spool for extension of the tape from the housing. The spool is rotatable in a second direction to coil the tape around the spool for retraction of the tape into the housing. The tape extends through the slit.

A housing stake is coupled the housing. The housing stake extends downwardly from the housing. The housing stake has a housing stake pointed end that is distally positioned relative to the housing wherein the housing stake is configured to be insertable into a ground surface to releasably secure the housing to the ground surface. A peg has a peg pointed end wherein the peg is configured to releasably secure the tape to the ground surface.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a boundary marking device according to an embodiment of the disclosure.

FIG. 2 is a front view of an embodiment of the disclosure.

FIG. 3 is a top view of an embodiment of the disclosure.

FIG. 4 is a side view of an embodiment of the disclosure.

FIG. 5 is an in-use view of an embodiment of the disclosure.

### DETAILED DESCRIPTION OF THE INVENTION

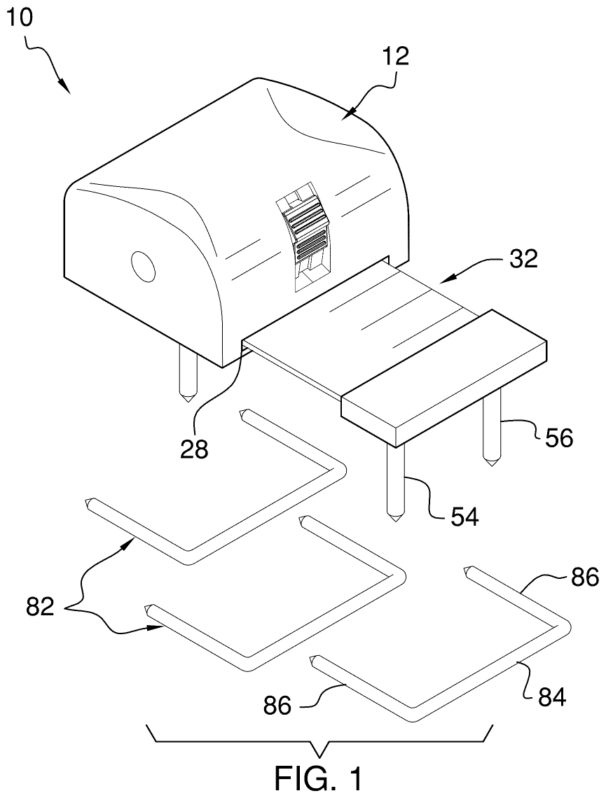

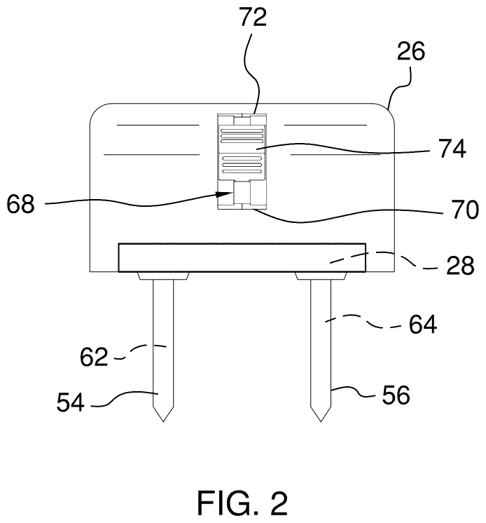

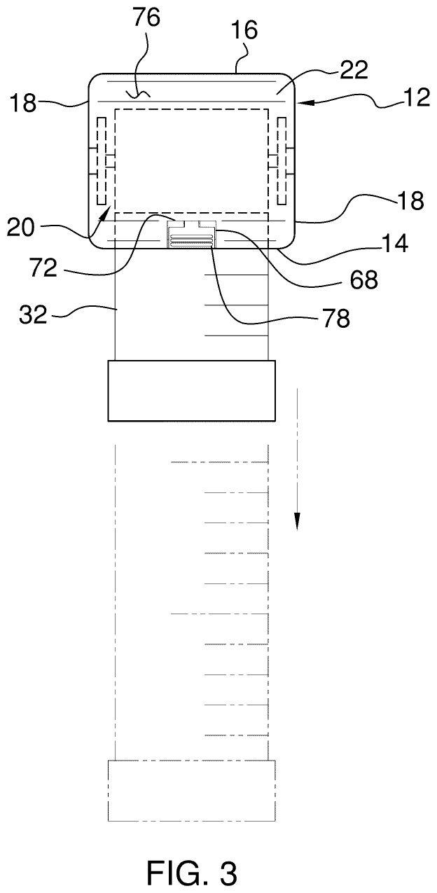

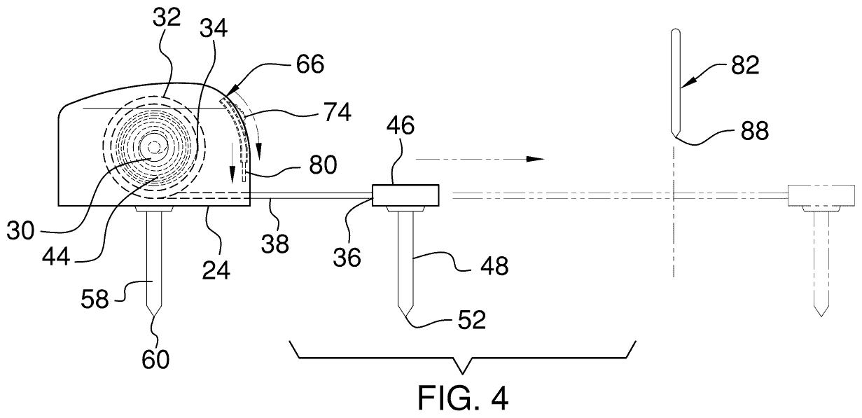

With reference now to the drawings, and in particular to FIGS. 1 through 5 thereof, a new sporting good embodying the principles and concepts of an embodiment of the disclosure and generally designated by the reference numeral 10 will be described.

As best illustrated in FIGS. 1 through 5, the boundary marking device 10 generally comprises a housing 12 with an interior space 20. The housing 12 generally includes a front end 14, a back end 16, and a pair of lateral ends 18 that is coupled to and extends between the front end 14 and the back end 16 to define the interior space 20. The housing 12 may also include a top side 22 and a bottom side 24. The bottom side 24 may be planar. Each lateral end of the pair of lateral ends 18 includes a respective upper edge 26. The respective upper edge 26 of each lateral end of the pair of lateral ends 18 may be convexly arcuate between the top side 22 and the front end 14.

A slit 28 extends through the housing 12 into the interior space 20. For example, the slit 28 may extend through the front end 14 of the housing 12. The slit 28 may be positioned proximate to the bottom side 24. The slit 28 may be elongated between the pair of lateral ends 18 of the housing 12. For example, the slit 28 may be rectangular. The slit 28 may be parallel to the bottom side 24 of the housing 12.

A spool 30 is rotatably coupled to the housing 12. The spool 30 is generally positioned in the interior space 20. The spool 30 may extend between the pair of lateral ends 18. The spool 30 may be spaced from the top side 22. The spool 30 may be spaced from the bottom side 24. The spool 30 may be spaced from the front end 14. The spool 30 may be spaced from the back end 16.

A tape 32 is coiled around the spool 30. The spool 30 is rotatable in a first direction to uncoil the tape 32 from the spool 30 for extension of the tape 32 from the housing 12. The spool 30 is rotatable in a second direction to coil the tape 32 around the spool 30 for retraction of the tape 32 into the housing 12. The tape 32 extending through the slit 28 as the tape 32 is extended and retracted relative to the housing 12. The tape 32 may have a length between 50.0 feet and 200.0 feet. The tape 32 may have a width between 1.0 inch and 4.0 inches.

The tape 32 may be a high visibility color that is designed to increase visibility of the tape 32 to a user. For example, the high visibility color may be a florescent or neon color such as green, yellow, orange, red, blue, purple, and pink. The tape 32 may be made of a synthetic polymer material, such as nylon.

The tape 32 may further include a first end 34 that is coupled to the spool 30. A second end 36 is distal to, or spaced from, the first end 34. An elongated body 38 extends between the first end 34 and the second end 36. The elongated body 38 is generally non-adhesive.

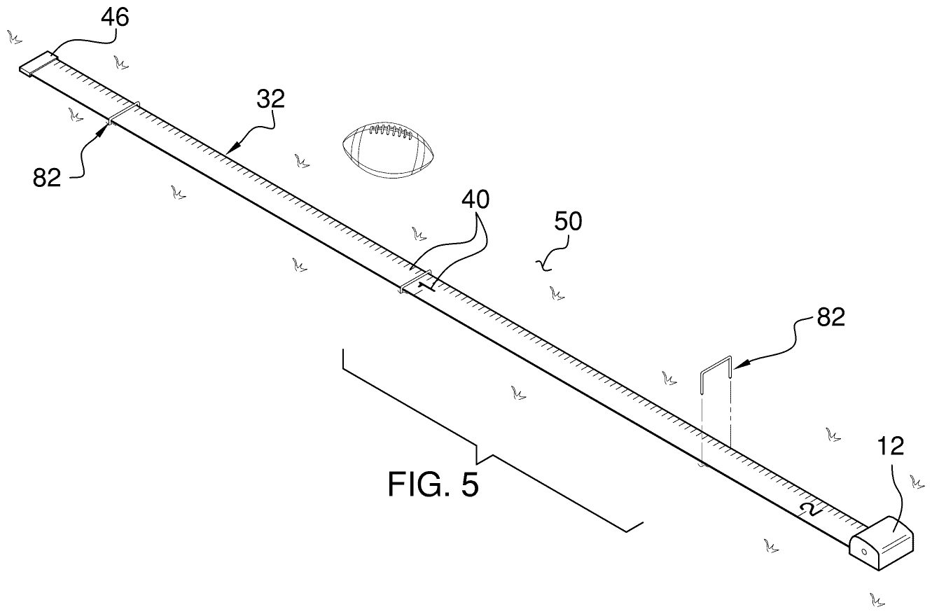

A plurality of indicia 40 may be printed on the elongated body 38. For example, the plurality of indicia 40 may include measurements wherein the tape 32 is configured to facilitate the user in measuring a distance along a ground surface 50. The measurements are typically equidistantly spaced along the elongated body 38. For example, the measurements may include a plurality of yard measurements wherein the tape 32 is configured to facilitate the user in measuring the distance along an athletic field, such as a football field or a soccer field. The tape 32 may be positioned along a boundary of the athletic field to mark or define the boundary. The measurements may indicate or measure various distances along the boundary. In some embodiments, such as the embodiment shown in FIG. 5, the plurality of indicia 40 may include both numbers and lines, such as yard numbers and lines positioned at regular intervals between the yard numbers to indicate the measurements between a sequential pair of the yard numbers.

A spring 44 may be coupled to the spool 30. The spring 44 is generally coupled to the first end 34 of the tape 32. The spring 44 winds around the spool 30 when the spool 30 rotates in the first direction to uncoil the tape 32 from the spool 30 for extension of the tape 32 from the housing 12. The spring 44 unwinds from the spool 30 when the spool 30 rotates in the second direction to coil the tape 32 around the spool 30 for retraction of the tape 32 into the housing 12. The spring 44 has a spring tension. The spring tension increases as the spring 44 winds around the spool 30. The spring tension is released when the spring 44 unwinds from the spool 30 wherein the spring 44 is configured to retract the tape 32 into the housing 12.

An end cap 46 may be coupled to the second end 36 of the tape 32. The end cap 46 may be a rigid material. The end cap 46 generally has a size exceeding a size of the slit 28 wherein the end cap 46 inhibits the second end 36 from retracting into the housing 12.

A tape stake 48 may be coupled to the end cap 46. The tape stake 48 may extend downwardly from the end cap 46. The tape stake 48 may be perpendicular to the end cap 46. The tape stake 48 may have a tape stake pointed end 52 that is distally positioned relative to the end cap 46 wherein the tape stake 48 is configured to be insertable into the ground surface 50 to releasably secure the second end 36 of the tape 32 to the ground surface 50.

The tape stake 48 may further include a tape stake primary rod 54 that may be positioned proximate to a first lateral end of the pair of lateral ends 18 of the housing 12 when the tape 32 is fully retracted into the housing 12. A tape stake secondary rod 56 may be spaced from the tape stake primary rod 54. The tape stake secondary rod 56 may be aligned with the tape stake primary rod 54 on the end cap 46. For example, the tape stake secondary rod 56 may be positioned proximate to a second lateral end of the pair of lateral ends 18 of the housing 12 when the tape 32 is fully retracted into the housing 12.

A housing stake 58 may be coupled to the housing 12. The housing stake 58 may extend downwardly from the housing 12. For example, the housing stake 58 may be positioned on the bottom side 24 of the housing 12. The housing stake 58 may be perpendicular to the bottom side 24 of the housing 12. The housing stake 58 may have a housing stake pointed end 60 that is distally positioned relative to the housing 12 wherein the housing stake 58 is configured to be insertable into the ground surface 50 to releasably secure the housing 12 to the ground surface 50.

The housing stake 58 may further include a housing stake primary rod 62 that may be positioned proximate to the first lateral end of the pair of lateral ends 18. A housing stake secondary rod 64 may be spaced from the housing stake primary rod 62. The housing stake secondary rod 64 may be aligned with the housing stake primary rod 62. For example, the housing stake secondary rod 64 may be positioned proximate to the second lateral end of the pair of lateral ends 18.

A tape lock 66 may be coupled to the housing 12. The tape lock 66 is releasably engageable with the tape 32 wherein the tape lock 66 selectively inhibits the tape 32 from being extended or retracted relative to the housing 12.

For example, the tape lock 66 may include a channel 68 that extends into the front end 14 of the housing 12. The channel 68 may be perpendicular to the slit 28. The channel 68 may have a bottom edge 70 that is positioned proximate to the slit 28. The channel 68 may have a top edge 72 that is spaced from the bottom edge 70. For example, the top edge 72 may be positioned on the top side 22 of the housing 12 and the bottom edge 70 may be positioned on the front end 14 of the housing 12.

A plate 74 may be slidably coupled to the housing 12. The plate 74 is generally positioned in the channel 68 wherein the plate 74 is slidable along the channel 68 between the top edge 72 and the bottom edge 70. The plate 74 may be positioned on an exterior surface 76 of the housing 12 wherein the plate 74 is configured to be slidable by the user. The plate 74 may have a textured outer surface 78. The textured outer surface 78 is generally designed to increase friction between the user and the plate 74, and to facilitate the user in sliding the plate 74 along the channel 68.

A tongue 80 may be coupled to the plate 74. The tongue 80 is generally positioned in the interior space 20. The tongue 80 extends downwardly from the plate 74 toward the tape 32. The tongue 80 contacts the tape 32 to inhibit the tape 32 from extending and retracting when the plate 74 is positioned at the bottom edge 70 of the channel 68. The tongue 80 is spaced from the tape 32 to facilitate the tape 32 in extending and retracting when the plate 74 is positioned at the top edge 72 of the channel 68.

A peg 82 may be releasably couplable to the tape 32 wherein the peg 82 is configured to releasably secure the tape 32 to the ground surface 50. For example, the peg 82 may have a peg pointed end 88 that is designed to be insertable into the ground surface 50.

In some embodiments, the peg 82 may be one of a plurality of pegs 82 designed to releasably secure the elongated body 38 of the tape 32 to the ground surface 50. For example, each peg of the plurality of pegs 82 may include a rail 84. The rail 84 may have a length that is complementary to the width of the tape 32 wherein the rail 84 is positionable over the elongated body 38 of the tape 32. A pair of shafts 86 may be coupled to opposing lateral ends of the rail 84. The pair of shafts 86 is generally positionable on opposing sides of the tape 32. Each shaft of the pair of shafts 86 may include the peg pointed end 88. The peg pointed end 88 is generally distally positioned relative to the rail 84 wherein each shaft of the pair of shafts 86 is configured to be insertable into the ground surface 50.

In use, the tape 32 can be extended outwardly from the housing 12 by pulling on the second end 36 of the tape 32. The tape stake 48 at the second end 36 of the tape 32 can be inserted into the ground surface 50, and the elongated body 38 can extend from the second end 36 of the tape 32 to define a boundary line of an athletic field, as shown in FIG. 5. Once the tape 32 is extended to the desired length of the boundary line, the tape lock 66 can be engaged to inhibit the tape 32 from being extended or retracted relative to the housing 12. For example, the user can slide the plate 74 downward toward the bottom edge 70 of the channel 68 until the tongue 80 contacts the tape 32 and secures the position of the tape 32 within the slit 28. The housing stake 58 may be inserted into the ground surface 50 to secure the housing 12 to the ground surface 50.

The high visibility color of the tape 32 increases visibility of the tape 32 along the ground surface 50, so that the user can easily see the boundary line of the athletic field. The plurality of indicia 40 may further increase visibility of the tape 32, for example when the plurality of indicia 40 include designs, logos, images, or figures. In embodiments including measurements, the plurality of indicia 40 can facilitate the user in recognizing certain distances along the boundary line of the athletic field. The peg, or the plurality of pegs 82, can be positioned over the elongated body 38 of the tape 32 to secure the elongated body 38 to the ground surface 50. For example, the plurality of pegs 82 may inhibit the elongated body 38 from catching wind and rising upwards from the ground surface 50 in windy conditions.

The tape 32 can be easily removed from the ground surface 50 by pulling the tape stake 48 out of the ground surface 50. Likewise, the housing 12 can be removed from the ground surface 50 by pulling the housing stake 58 out of the ground surface 50. The tape 32 may be retracted into the housing 12 by releasing the tape lock 66. For example, once the tape lock 66 is released, the spring tension of the spring 44 may retract the tape 32 into the housing 12 and coil the tape 32 onto the spool 30.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A measuring tape assembly comprising:
a housing having an interior space;
a slit extending through the housing into the interior space;
a spool being rotatably coupled to the housing, the spool being positioned in the interior space;
a tape being coiled around the spool, the spool being rotatable in a first direction to uncoil the tape from the spool for extension of the tape from the housing, the spool being rotatable in a second direction to coil the tape around the spool for retraction of the tape into the housing, the tape extending through the slit;
a housing stake being coupled the housing, the housing stake extending downwardly from the housing, the housing stake having a housing stake pointed end being distally positioned relative to the housing wherein the housing stake is configured to be insertable into a ground surface to releasably secure the housing to the ground surface; and
a peg having a peg pointed end wherein the peg is configured to releasably secure the tape to the ground surface.

2. The measuring tape assembly of claim 1, the tape further comprising:
a first end being coupled to the spool;
a second end being distal to the first end; and
an elongated body extending between the first end and the second end.

3. The measuring tape assembly of claim 2, the elongated body further comprising a plurality of indicia being printed on the elongated body, the plurality of indicia including measurements wherein the tape is configured to facilitate the user in measuring a distance along a ground surface.

4. The measuring tape assembly of claim 2, further comprising an end cap being coupled to the second end of the tape.

5. The measuring tape assembly of claim 4, further comprising a tape stake being coupled to the end cap, the tape stake extending downwardly from the end cap, the tape stake having a tape stake pointed end being distally positioned relative to the end cap wherein the tape stake is configured to be insertable into the ground surface to releasably secure the second end of the tape to a ground surface.

6. The measuring tape assembly of claim 5, the tape stake further comprising:
a tape stake primary rod; and
a tape stake secondary rod being spaced from the tape stake primary rod.

7. The measuring tape assembly of claim 6, wherein the tape stake secondary rod is aligned with the tape stake primary rod.

8. The measuring tape assembly of claim 6, wherein the tape stake primary rod is positioned proximate to a first lateral end of the housing when the tape is fully retracted into the housing and wherein the tape stake secondary rod is positioned proximate to a second lateral end of the housing when the tape is fully retracted into the housing.

9. The measuring tape assembly of claim 1, further comprising a spring being coupled to the spool, the spring being attached to the tape, the spring winding around the spool when the spool rotates in the first direction to uncoil the tape from the spool for extension of the tape from the housing, the spring unwinding from the spool when the spool rotates in the second direction to coil the tape around the spool for retraction of the tape into the housing, the spring having a spring tension, the spring tension increasing as the spring winds around the spool, the spring tension being released when the spring unwinds from the spool wherein the spring is configured to retract the tape into the housing.

10. The measuring tape assembly of claim 1, the housing stake further comprising:
a housing stake primary rod being positioned proximate to a first lateral end of the housing; and
a housing stake secondary rod being spaced from the housing stake primary rod.

11. The measuring tape assembly of claim 1, further comprising a tape lock being coupled to the housing, the tape lock being releasably engageable with the tape wherein the tape lock selectively inhibits the tape from being extended or retracted relative to the housing.

12. The measuring tape assembly of claim 11, the tape lock further comprising:
a channel extending into the housing, the channel having a bottom edge being positioned proximate to the slit, the channel having a top edge being spaced from the bottom edge;
a plate being slidably coupled to the housing, the plate being positioned in the channel wherein the plate is slidable along the channel between the top edge and the bottom edge; and
a tongue being coupled to the plate, the tongue being positioned in the interior space of the housing, the tongue extending downwardly from the plate toward the tape, the tongue contacting the tape to inhibit the tape from being extended and retracted when the plate is positioned at the bottom edge of the channel, the tongue being spaced from the tape to facilitate the tape in being extended and retracted when the plate is positioned at the top edge of the channel.

13. The measuring tape assembly of claim 1, wherein the peg is one of a plurality of pegs.

14. The measuring tape assembly of claim 1, the peg further comprising:
a rail being positionable over the tape; and
a pair of shafts being coupled to opposing lateral ends of the rail.

15. The measuring tape assembly of claim 14, each shaft of the pair of shafts further comprising a peg pointed end being distally positioned relative to the rail wherein each shaft of the pair of shafts is configured to be insertable into the ground surface.

16. A measuring tape assembly comprising:
a housing having a front end, a back end, and a pair of lateral ends being coupled to and extending between the front end and the back end to define an interior space, the housing having a top side and a bottom side, the bottom side being planar, each lateral end of the pair of lateral ends having a respective upper edge, the respective upper edge of each lateral end of the pair of lateral ends being convexly arcuate between the top side and the front end:
a slit extending through the front end of the housing into the interior space, the slit being positioned proximate to the bottom side;
a spool being rotatably coupled to the housing, the spool being positioned in the interior space, the spool extending between the pair of lateral ends;
a tape being coiled around the spool, the spool being rotatable in a first direction to uncoil the tape from the spool for extension of the tape from the housing, the spool being rotatable in a second direction to coil the tape around the spool for retraction of the tape into the housing, the tape extending through the slit, the tape being a high visibility color wherein the high visibility color is configured to increase visibility of the tape to a user, the tape having a length between 50.0 feet and 200.0 feet, the tape having a width between 1.0 inch and 4.0 inches, the tape being a synthetic polymer material, the tape further including:
a first end being coupled to the spool;
a second end being distal to the first end;
an elongated body extending between the first end and the second end, the elongated body being non-adhesive, the elongated body including:
a plurality of indicia being printed on the elongated body, the plurality of indicia including measurements wherein the tape is configured to facilitate the user in measuring a distance along a ground surface;
a spring being coupled to the spool, the spring being attached to the first end of the tape, the spring winding around the spool when the spool rotates in the first direction to uncoil the tape from the spool for extension of the tape from the housing, the spring unwinding from the spool when the spool rotates in the second direction to coil the tape around the spool for retraction of the tape into the housing, the spring having a spring tension, the spring tension increasing as the spring winds around the spool, the spring tension being released when the spring unwinds from the spool wherein the spring is configured to retract the tape into the housing;
an end cap being coupled to the second end of the tape, the end cap being a rigid material, the end cap having a size exceeding a size of the slit wherein the end cap inhibits the second end from being retracted into the housing;
a tape stake being coupled to the end cap, the tape stake extending downwardly from the end cap, the tape stake having a tape stake pointed end being distally positioned relative to the end cap wherein the tape stake is configured to be insertable into the ground surface to releasably secure the second end of the tape to the ground surface, the tape stake being perpendicular to the end cap, the tape stake further including:
a tape stake primary rod being positioned proximate to a first lateral end of the pair of lateral ends of the housing when the tape is fully retracted into the housing;
a tape stake secondary rod being spaced from the tape stake primary rod, the tape stake secondary rod being aligned with the tape stake primary rod, the tape stake secondary rod being positioned proximate to a second lateral end of the pair of lateral ends of the housing when the tape is fully retracted into the housing;
a housing stake being coupled to the bottom side of the housing, the housing stake extending downwardly from the housing, the housing stake having a housing stake pointed end being distally positioned relative to the housing wherein the housing stake is configured to be insertable into the ground surface to releasably secure the housing to the ground surface, the housing stake being perpendicular to the bottom side of the housing, the housing stake further including:
a housing stake primary rod being positioned proximate to the first lateral end of the pair of lateral ends;
a housing stake secondary rod being spaced from the housing stake primary rod, the housing stake secondary rod being aligned with the housing stake primary rod, the housing stake secondary rod being positioned proximate to the second lateral end of the pair of lateral ends;
a tape lock being coupled to the housing, the tape lock being releasably engageable with the tape wherein the tape lock selectively inhibits the tape from being extended or retracted relative to the housing, the tape lock including:
a channel extending into the front end of the housing, the channel being positioned above the slit, the channel being perpendicular to the slit, the channel having a bottom edge being positioned proximate to the slit, the channel having a top edge being spaced from the bottom edge, the top edge being positioned on the top side of the housing, the bottom edge being positioned on the front end of the housing;
a plate being slidably coupled to the housing, the plate being positioned in the channel wherein the plate is slidable along the channel between the top edge and the bottom edge, the plate being positioned on an exterior surface of the housing wherein the plate is configured to be slidable by the user, the plate having a textured outer surface, the textured outer surface being configured to facilitate the user in sliding the plate along the channel;
a tongue being coupled to the plate, the tongue being positioned in the interior space, the tongue extending downwardly from the plate toward the tape, the tongue contacting the tape to inhibit the tape from being extended and retracted when the plate is positioned at the bottom edge of the channel, the tongue being spaced from the tape to facilitate the tape in being extended and retracted when the plate is positioned at the top edge of the channel; and
a plurality of pegs being configured to releasably secure the elongated body of the tape to the ground surface, each peg of the plurality of pegs including:
a rail having a length being complementary to the width of the tape wherein the rail is positionable over the elongated body of the tape;
a pair of shafts being coupled to opposing lateral ends of the rail, the pair of shafts being positionable on opposing sides of the tape, each shaft of the pair of shafts including:
a peg pointed end being distally positioned relative to the rail wherein each shaft of the pair of shafts is configured to be insertable into the ground surface.
